(19) United States
(12) Patent Application Publication
(10) Pub. No.: US 2026/0163232 A1
(43) Pub. Date: Jun. 11, 2026

(54) ADJUSTED DIVERGENCE RADAR ANTENNA

(71) Applicant: Joyson Safety Systems Acquisition LLC, Auburn Hills, MI (US)

(72) Inventors: Joshua Ramaglia, Broken Arrow, OK (US); Michael Fleschner, Rochester Hills, MI (US); Babak Bakhtiar, Richmond Hill (CA)

(21) Appl. No.: 19/412,097

(22) Filed: Dec. 8, 2025

Related U.S. Application Data
(60) Provisional application No. 63/728,736, filed on Dec. 6, 2024.

(51) Int. Cl. H01Q 1/32; H01Q 21/06

(52) U.S. Cl. CPC H01Q 1/3233; H01Q 21/061

(57) ABSTRACT

Described and disclosed herein are systems, methods and devices of in-vehicle radar comprised of an antenna array having a plurality of emitters and receivers, wherein the emitters and receivers are configured such that the divergence of the radar beams is concentrated on specific regions of interest, or to spread the divergence in a way to make the detection region uniform within the vehicle.

### CROSS-REFERENCE TO RELATED APPLICATION

This application claims priority to and benefit of U.S. Provisional Patent Application Ser. No. 63/728,736 filed Dec. 6, 2024, which is fully incorporated by reference and made a part hereof.

### BACKGROUND

In today's vehicles, including automobiles, radar may be used not only to detect conditions and/or objects outside of the vehicle, it also may be used in the interior cabin of the vehicle to monitor and detect various parameters, such as the presence of people, animals, objects, their location, and their movements. This technology can improve the safety, comfort, and convenience of drivers and passengers. Some non-limiting examples of uses of radar in the cabin of a vehicle may include passenger detection, where radar detects the number of people in the vehicle and their location. It can also identify adults, children, and animals. Another use may be child presence detection, where radar can detect if a child has been left behind in the car, even if they are under a blanket or in the footwells. Radar can improve the accuracy of seatbelt reminders by preventing heavy objects from triggering them. Radar can help determine the speed at which airbags should deploy to reduce the risk of injury to passengers. Radar can detect if the driver is drowsy. Radar can detect the breath and heart rate of the occupants. Radar can detect if someone is entering the vehicle. Radar information can be communicated to rescue workers in the event of an accident, and the like.

However, because of limitations imposed by physics, when an electromagnetic beam is created from any source, it prefers to spread out as it propagates through space (diverges). Beam divergence from systems like multi antenna radars is specifically concentrated at the edges of the antenna array, leading to a distorted imaging field towards those edges. This divergence may affect the accuracy of the radar system and, in turn, affect the systems using the radar signals.

Therefore, devices, systems and methods that overcome challenges in the conventional art are desired, including those challenges mentioned above.

### SUMMARY

Described and disclosed herein are systems, methods and devices of in-vehicle radar comprised of an antenna array having a plurality of emitters and receivers, wherein the emitters and receivers are configured such that the focus of the radar beams is concentrated on specific regions of interest, divergence of the radar beams is away from the regions of interest, and/or to spread divergence of the radar beams in a way to make the detection region uniform within the vehicle. In other works, the antenna array is configured to have better resolution in some areas within or proximate to the vehicle than in other areas.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views:

FIGS. 1A and 1B illustrate the radar concept of using time of flight and frequency modulation to determine range and doppler shift rate of reflective objects (dielectric properties affect reflection energy);

FIG. 2A illustrates a configuration of an array of transmitters (or emitters) Tx and receivers Rx that create a virtual array with resolution toward the center of the array greater than it is toward the edges;

FIG. 2B illustrates a configuration of an array of transmitters and receivers where adjacent transmitters are spaced further apart toward the middle of the vertically-aligned column of transmitters, and similarly the receivers are spaced further apart toward the center of the row of receivers, thus providing divergence (changes in resolution) of the virtual array than what was provided with equally-spaced transmitters and receivers as was shown in FIG. 2A;

FIG. 2C illustrates a projection of the field of view (FOV) of the virtual array of FIG. 2A or 2B onto the interior of a vehicle, including occupants;

FIG. 3A illustrates an alternative configuration of an antenna array of transmitters and receivers, with the ensuing changes in resolution within the virtual array;

FIG. 3B illustrates a projection of the FOV of the virtual array of FIG. 3A onto the interior of a vehicle, including occupants;

FIG. 4A illustrates another example of an alternate configuration of an antenna array, with the ensuing changes in the virtual array;

FIG. 4B illustrates a projection of the FOV of the virtual array of FIG. 4A onto the interior of a vehicle, including occupants; and

FIGS. 5A-5D illustrate additional non-limiting exemplary configurations of antenna arrays of transmitters and receivers where each configuration affects resolution within the virtual array caused by divergence of the radar signals.

### DETAILED DESCRIPTION

To facilitate an understanding of the principles and features of various embodiments of the present disclosure, they are explained hereinafter with reference to their implementation in illustrative embodiments.

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising”, and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. As used herein, “exemplary” means an example of and is not intended to denote a preference or a preferred embodiment. Ranges may be expressed herein as from “about” one particular value, and/or to “about” another particular value. When such a range is expressed, an aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

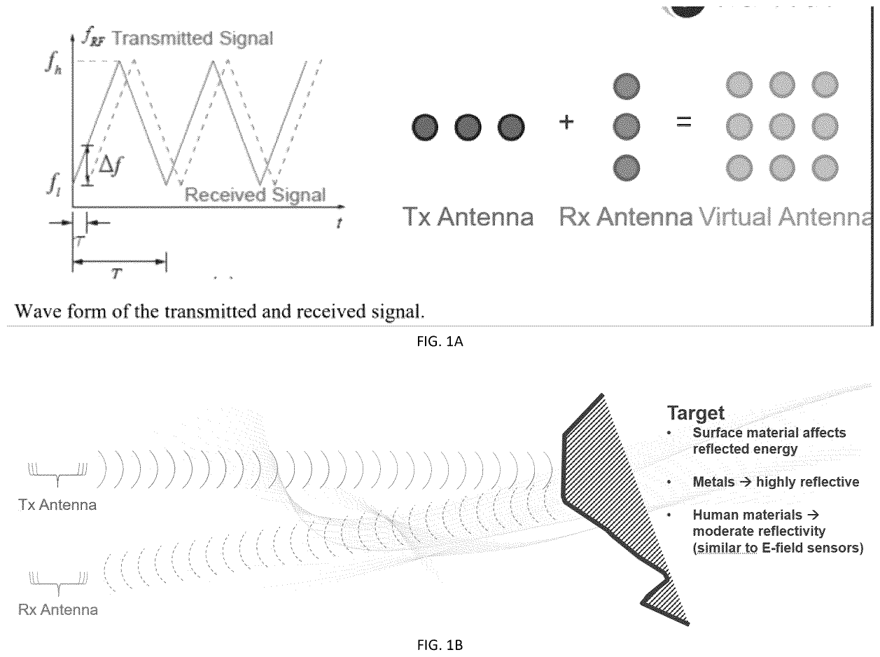

Radar is an acronym for radio detection and ranging. Typical in-cabin radar systems for interior monitoring use radio waves of 60-64 GHz whereas others use 20-25 GHz, though other frequencies are contemplated within the scope of this disclosure. As shown in FIGS. 1A and 1B, radar uses time of flight and frequency modulation to determine range and doppler shift rate of reflective objects (dielectric properties affect reflection energy).

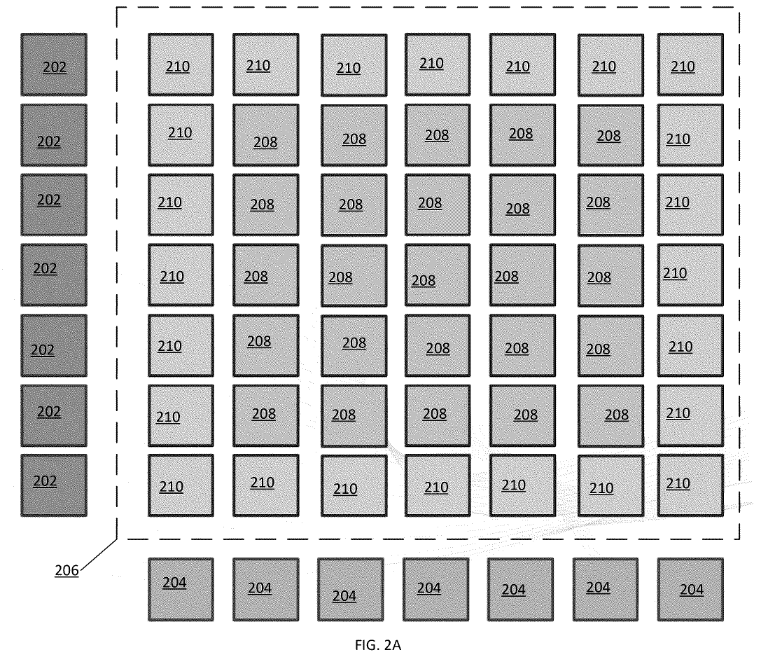

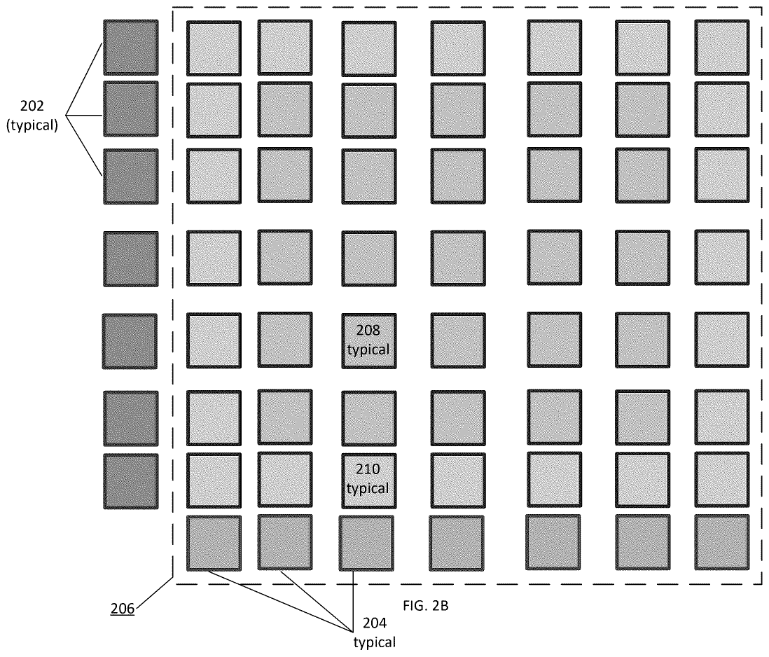

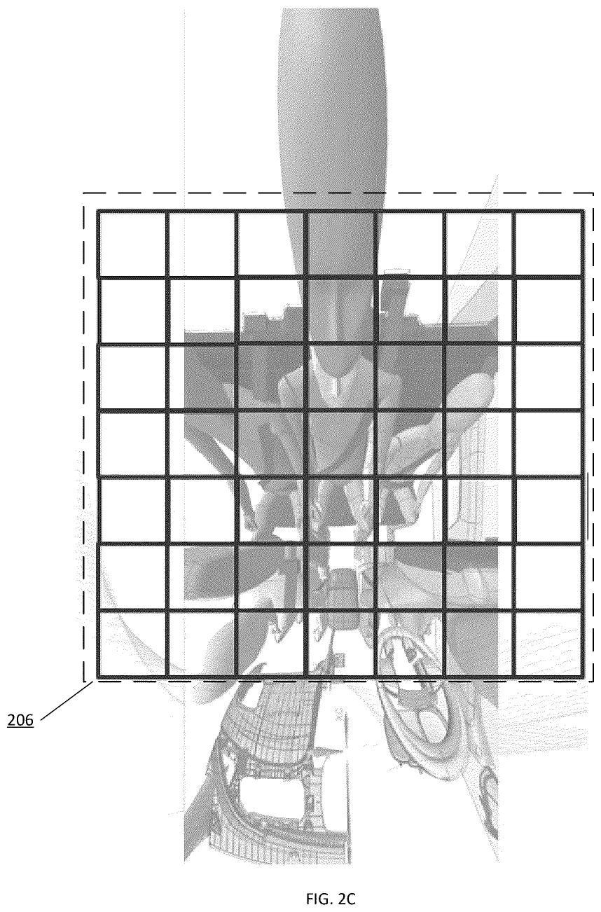

As shown in FIG. 2A, an array of transmitters (or emitters) Tx 202 and receivers Rx 204, creates a virtual array 206, with resolution toward the center 208 of the array 206 greater than it is toward the edges 210. By configuring the location(s) of the emitters 202 and receivers 204, objects, persons, movement, etc. within the bounds of the virtual array 206 are detected. It is to be appreciated that the location, size, and shading of the squares within the virtual array 206 represents resolution (ability to detect) within the array 206. Therefore, it can be shown that the configuration (number, size and location) of the transmitters 202 and receivers 204 affects the configuration of the virtual array 206 and resolution with the array 206. In some instances, the orientation of the transmitters 202 and/or the receivers 204 may be changed with respect to the interior of the vehicle to affect the configuration. FIG. 2B illustrates an example where adjacent transmitters 202 are spaced further apart toward the middle of the vertically-aligned column of transmitters 202, and similarly the receivers 204 are spaced further apart toward the center of the row of receivers 204, thus providing greater divergence (change in resolution) of the virtual array 206 toward its center than what was provided with equally-spaced transmitters 202 and receivers 204 as was shown in FIG. 2A. In the example shown in FIG. 2B, the resolution of the array 206 toward its center approaches that of the array 206 toward its edges 210.

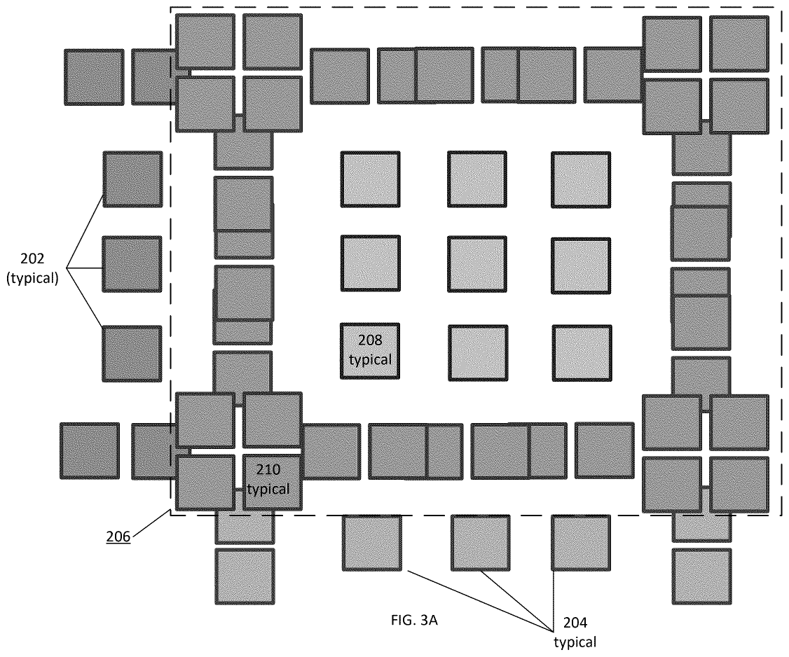

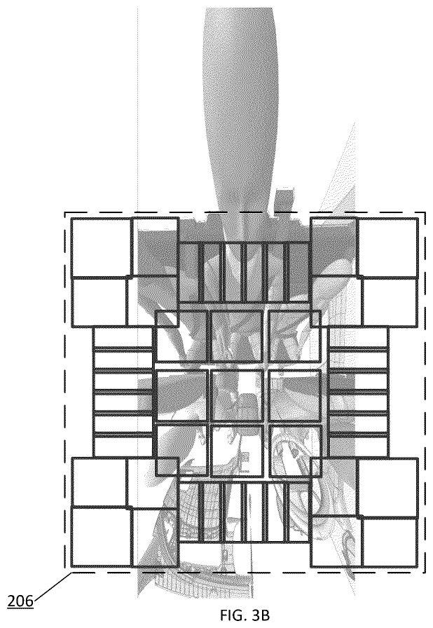

FIG. 2C is a projection of the field of view (FOV) of the virtual array 206 of FIG. 2A or 2B onto the interior of a vehicle, including occupants. This is a view from overhead the occupants. The generally uniform size of the rectangles illustrates uniform resolution within the array 206. The transmitters 202 and receivers 204 are not shown in FIG. 3B.

An alternative arrangement of transmitters 202 and receivers 204 is shown in FIG. 3A, with the ensuing changes in the virtual array 206. As shown in FIG. 3A, the virtual array 206 has increased resolution along a back seat head zone; increased resolution outside of the vehicle (anti-theft); and increased resolution around a steering wheel and a human-machine interface (HMI). Correspondingly, there is lower resolution in each seat, which is suitable for occupancy detection, while occupant classification (adult, child, animal, etc.) relies on outside regions 210 of detection having greater resolution.

FIG. 3B is a projection of the FOV of the virtual array 206 of FIG. 3A onto the interior of a vehicle, including occupants. Smaller rectangles illustrate areas of the array 206 having higher resolution, while larger rectangles indicate more divergence/less resolution. The view shown in FIG. 3B is from overhead the occupants. The transmitters 202 and receivers 204 are not shown in FIG. 3B.

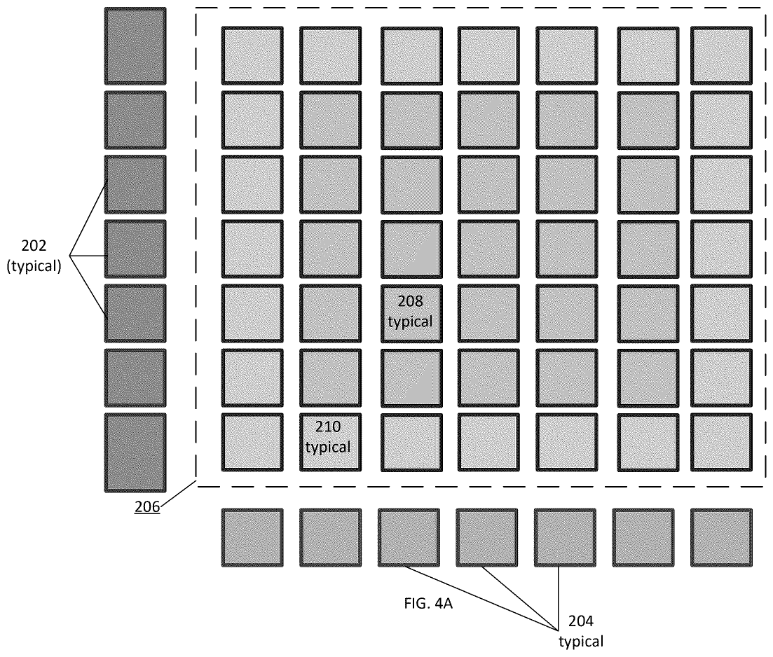

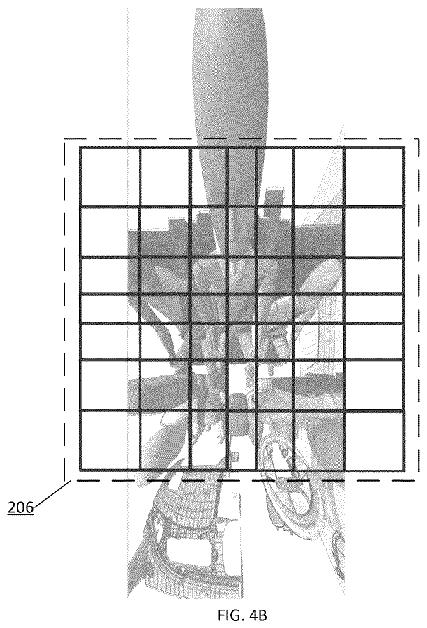

FIG. 4A illustrates another alternate arrangement of transmitters 202 and receivers 204, with the ensuing changes in the virtual array 206. The configuration of the transmitters 202 and receivers 204 results in the shown virtual array 206. FIG. 4B is a projection of the FOV of the virtual array 206 of FIG. 4A onto the interior of a vehicle, including occupants. This is a view from overhead the occupants.

As can be seen in FIGS. 4A and 4B, the shown configuration of the transmitters 202 and receivers 204 creates a higher resolution toward the center of the array 206, which is shown in the FOV of the array 206 as shown in FIG. 4B (as shown by the smaller rectangles toward the center of the array 206, and the larger rectangles toward the edges of the array 206). The transmitters 202 and receivers 204 are not shown in FIG. 4B. This would more readily identify occupants and provide their classification, among other uses.

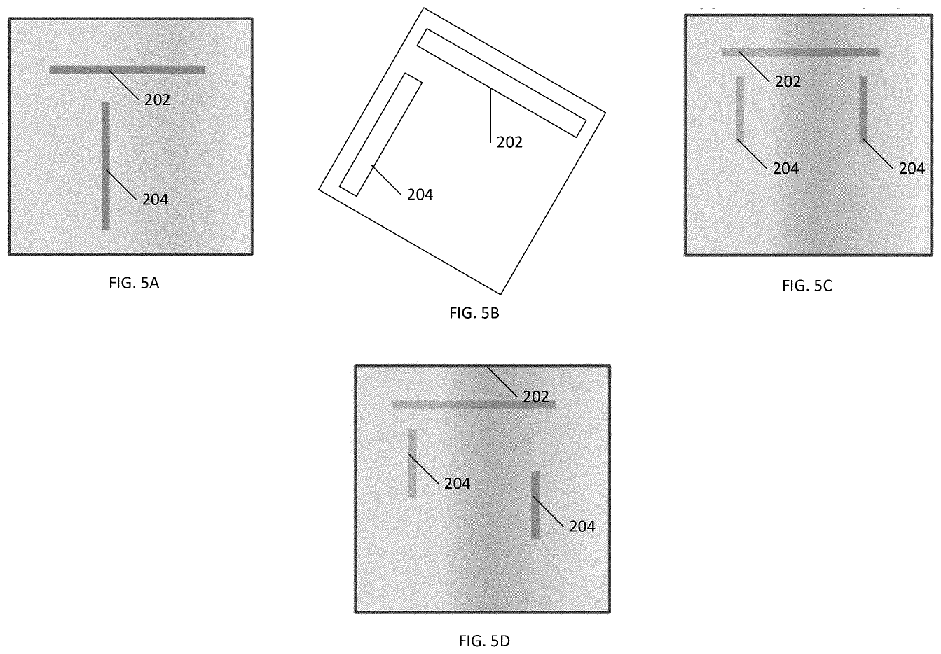

FIGS. 5A-5D illustrate additional non-limiting exemplary configurations of transmitters 202 and receivers 204 according to various aspects. Each configuration of transmitters 202 and receivers 204 affects resolution within the virtual array 206 caused by divergence of the radar signals, and its FOV.

In some instances, the receivers 204 and transmitters 202 may be mounted on a single board (generally, a printed circuit board (PCB), though in other instances the transmitters 202 and receivers 204 may be mounted on separate boards, or in some instances one or more transmitters 202 may be mounted on a board with one or more receivers 204, and the remaining transmitters 202 and transmitters 204 on various other boards.

Although example embodiments of the present disclosure are explained in some instances in detail herein, it is to be understood that other embodiments are contemplated. Accordingly, it is not intended that the present disclosure be limited in its scope to the details of construction and arrangement of components set forth in the following description or illustrated in the drawings. The present disclosure is capable of other embodiments and of being practiced or carried out in various ways.

It must also be noted that, as used in the specification and the appended claims, the singular forms “a,” “an” and “the” include plural referents unless the context clearly dictates otherwise. Ranges may be expressed herein as from “about” or “approximately” one particular value and/or to “about” or “approximately” another particular value. When such a range is expressed, other exemplary embodiments include from the one particular value and/or to the other particular value.

By “comprising” or “containing” or “including” is meant that at least the name compound, element, particle, or method step is present in the composition or article or method, but does not exclude the presence of other compounds, materials, particles, method steps, even if the other such compounds, material, particles, method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the present disclosure. Similarly, it is also to be understood that the mention of one or more components in a device or system does not preclude the presence of additional components or intervening components between those components expressly identified.

As discussed herein, a “subject” may be any applicable human, animal, or other organism, living or dead, or other biological or molecular structure or chemical environment, and may relate to particular components of the subject, for instance specific tissues or fluids of a subject (e.g., human tissue in a particular area of the body of a living subject), which may be in a particular location of the subject, referred to herein as an “area of interest” or a “region of interest.”

The term “about,” as used herein, means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%. In one aspect, the term “about” means plus or minus 10% of the numerical value of the number with which it is being used. Therefore, about 50% means in the range of 45%-55%. Numerical ranges recited herein by endpoints include all numbers and fractions subsumed within that range (e.g., 1 to 5 includes 1, 1.5, 2, 2.75, 3, 3.90, 4, 4.24, and 5).

Similarly, numerical ranges recited herein by endpoints include subranges subsumed within that range (e.g., 1 to 5 includes 1-1.5, 1.5-2, 2-2.75, 2.75-3, 3-3.90, 3.90-4, 4-4.24, 4.24-5, 2-5, 3-5, 1-4, and 2-4). It is also to be understood that all numbers and fractions thereof are presumed to be modified by the term “about.”

What is claimed is:

1. A vehicle radar system, comprising:
an antenna array comprising a plurality of radar transmitters and receivers, wherein the array is configured to create a virtual array having a field of view within an interior cabin of a vehicle, wherein a resolution within the field of view of the virtual array has a higher resolution in some areas of the interior cabin and a lower resolution in other areas of the interior cabin and/or the resolution is uniform within the interior cabin.

2. The system of claim 1, wherein the vehicle comprises an automobile.

3. The system of claim 1, wherein the array is positioned to provide an overhead view of the interior cabin.

4. The system of claim 1, wherein the resolution in the field of view is greater than or equal at edges of the virtual array than it is in an interior of the virtual array.

5. The system of claim 1, wherein the system is configured to detect objects, persons, animals, movement, and the like proximate an exterior of the vehicle cabin.

6. The system of claim 1, wherein configuring the antenna array comprises adjusting one or more of a number of radar transmitters, a number of radar receivers, locations of the radar transmitters respective to locations of the radar transmitters, sizes of the radar transmitters, sizes of the radar receivers, and/or orientations of the radar transmitters and/or radar receivers.

7. A method of detecting objects, persons, animals, or movement like within an interior cabin of a vehicle comprising:
providing an antenna array comprising a plurality of radar transmitters and receivers, wherein the array is configured to create a virtual array having a field of view within an interior cabin of a vehicle, wherein a resolution within the field of view of the virtual array has a higher resolution in some areas of the interior cabin and a lower resolution in other areas of the interior cabin and/or the resolution is uniform within the interior cabin; and
detecting the objects, persons, animals, or movement within an interior cabin of a vehicle.

8. The method of claim 7, wherein the vehicle comprises an automobile.

9. The method of claim 7, wherein the array is positioned to provide an overhead view of the interior cabin.

10. The method of claim 7, wherein the resolution in the field of view is greater than or equal at edges of the virtual array than it is in an interior of the virtual array.

11. The method of claim 7, wherein the system is configured to detect objects, persons, animals, movement, and the like proximate an exterior of the vehicle cabin.

12. The method of claim 1, wherein configuring the antenna array comprises adjusting one or more of a number of radar transmitters, a number of radar receivers, locations of the radar transmitters respective to locations of the radar transmitters, sizes of the radar transmitters, sizes of the radar receivers, and/or orientations of the radar transmitters and/or radar receivers.
